(19) United States
(12) Patent Application Publication
(10) Pub. No.: US 2003/0088757 A1
(43) Pub. Date: May 8, 2003

(54) Efficient high performance data operation element for use in a reconfigurable logic environment

(76) Inventors: Joshua Lindner, Canton, MA (US); Gary Lai, Sunnyvale, CA (US); Bradley Taylor, Oakland, CA (US); Peter Lam, Santa Clara, CA (US); Mark Rollins, Stittsville (CA); Vladimir Dinkevich, Mountain View, CA (US); Craig B. Greenberg, Sunnyvale, CA (US); Christopher E. Phillips, San Jose, CA (US); Hsin Wang, Fremont, CA (US)

Correspondence Address: Robert E Krebs, Thelen Reid and Priest LLP, P O Box 640640, San Jose, CA, 95164-0640, US

(21) Appl. No.: 10/135,849

(22) Filed: May 1, 2002

Related U.S. Application Data
(60) Provisional application No. 60/288,298, filed on May 2, 2001.

(51) Int. Cl. G06F 15/00

(52) U.S. Cl. 712/37; 712/229

(57) ABSTRACT

A reconfigurable chip is described using a reconfigurable functional unit including a shifter unit, arithmetic logic unit and multiplexers. The data path units are interconnected to other data path units. The interconnection is preferably done by transferring word length data. The shifter allows for the word length data to be adjusted for use in the arithmetic logic unit. In a preferred embodiment the reconfigurable functional units are controlled by reconfigurable functional unit instructions. The reconfigurable functional unit instructions preferably are stored in a reconfigurable functional unit instruction memory which is addressed by a state machine on the chip.

### RELATED APPLICATION/PRIORITY

This application claims priority under 35 U.S.C. §119 to U.S. Provisional Application No. 60/288,298 entitled EFFICIENT HIGH PERFORMANCE DATA OPERATION ELEMENT FOR USE IN A RECONFIGURABLE LOGIC ENVIRONMENT and filed on May 2, 2001, the entire content of which is hereby incorporated by reference.

### BACKGROUND OF THE INVENTION

The present invention relates to reconfigurable logic chips, especially reconfigurable logic chips used for reconfigurable computing.

Field programmable gate arrays (FPGAs) are programmable chips that can implement different configurations. Typically a design is created using design tools and a FPGA is configured for a specific design. Although designs can be changed, typically the FPGA uses a single configuration due to the relatively long time required to change a configuration compared to the operation time of the chip.

Recently reconfigurable chips designed to quickly switch portions of an algorithm on to a reconfigurable chip have been created. These reconfigurable chips are designed to use the reconfigurable elements of the chip so as to provide resources for the implementation portions of an algorithm.

It is desired to have a data operation element or reconfigurable functional unit for use in a reconfigurable chip that implements an improved design to more effectively implement algorithms on a reconfigurable chip.

### SUMMARY OF THE INVENTION

The present invention concerns a reconfigurable chip, including multiple reconfigurable functional units (such as a data path unit) adapted to implement different functions. The reconfigurable function units preferably include multiplexers, at least one shifting unit and at least one arithmetic logic unit (ALU). The reconfigurable functional units are configured by reconfigurable functional unit instructions. The instructions control the configuration of the multiplexer and shifting unit and the ALU. The reconfigurable chip also includes interconnect adapted to connect together the reconfigurable functional units. In this way data can be passed between the reconfigurable functional units.

The reconfigurable functional unit instruction preferably includes a number of fields for the multiplexers, the shifter unit and the arithmetic logic unit. These fields configure these elements in the reconfigurable functional unit in a desired way.

In a preferred embodiment, there is an associated instruction memory for each reconfigurable functional unit has an associated instruction memory. The instruction memory stores multiple instructions for the reconfigurable functional unit. In a preferred embodiment, the state machine addresses the instruction memory to determine the next instruction to be loaded into the reconfigurable functional unit. In one preferred embodiment, the reconfigurable functional units provide feedback to the state machine indicating when a function is finished and thus when the next function can be loaded into the reconfigurable functional unit.

In one embodiment, the shifter unit is configurable with a number of different modes. These modes are preferably selectable by a field of the reconfigurable functional unit instruction.

In one embodiment, interconnect elements are adapted to selectively connect some of the reconfigurable functional units to transfer word length data. The transferred data preferably has a fixed data length of 32 bits or greater. The fixed length data transfer allows interconnect system to be simplified at the loss of flexibility in the data transfer. The shifting unit in the reconfigurable functional unit allows the arithmetic logic unit to operate on different bits in the word length input data of the reconfigurable functional unit compensating for the fixed structure of the interconnect elements. Thus, if needed data is in a certain location within a word, the shifter can move that bit location to the proper position for manipulation by the arithmetic logic unit.

Another embodiment of the present invention comprises using a multiplexer with a delay unit input and an input that bypasses the delay unit. In this manner the reconfigurable functional unit can implement a variable delay increasing the flexibility of the system.

### BRIEF DESCRIPTION OF THE DRAWING FIGURES

FIG. 1 is an overview of the reconfigurable chip of one embodiment of the present invention;

FIG. 2 is a simplified diagram of a reconfigurable functional unit of one embodiment of the present invention;

FIG. 3 is a diagram of a reconfigurable functional unit of one embodiment of the present invention;

FIG. 4 is a diagram of a multiplier unit which can be used with the embodiment of the present invention;

FIG. 5 is a diagram of one slice of the reconfigurable functional unit shown in FIG. 1 illustrating the interconnection between the data path units;

FIG. 6 is a diagram illustrating the connections between the data path unit and the horizontal and vertical bus lines;

FIG. 7 is a diagram illustrating the interconnection of a data path unit in one tile to a data path unit in another tile;

FIG. 8 is a diagram illustrating the interconnection of the data path units and a local system memory of one embodiment of the present invention;

FIG. 9 is a diagram illustrating a state machine and functional block configuration memory producing the instruction of configuration information for the functional block data unit;

FIG. 10A is a diagram illustrating the interconnection of a state machine, configuration state memory and data path unit of the present invention, showing the instruction and instruction fields for the data path unit;

FIG. 10B is a diagram illustrating a data path unit using a decoder for at least part of the instruction;

FIG. 11 is a diagram illustrating the control system configuration memory at data path unit as one embodiment of the present invention;

FIG. 12 is a diagram of an interconnection logic unit for use in one embodiment of the present invention;

FIGS. 13A and 13B are charts illustrating the portions of the instructions for the ALU;

FIG. 14 is a diagram illustrating the flags for the system of one embodiment of the present invention;

FIG. 15 is a diagram illustrating the shifting mode for shifter;

FIG. 16 is a diagram of the instruction of one embodiment of the shifter;

FIG. 17 is a diagram illustrating the operation of the shifter of FIG. 16;

FIG. 18 is a diagram of a logic system using a multiple master latches of one embodiment of the present invention;

FIG. 19 is a diagram illustrating the background and foreground plane latches of one embodiment of the present invention;

FIG. 20 is a diagram of one embodiment of a reconfigurable functional unit for a data path in one embodiment of the present invention;

FIG. 21 is a diagram of the input multiplexers for the system of FIG. 20;

FIG. 22 is a diagram of the shifting mode for the shifter of one embodiment of the present invention;

FIG. 23 is a diagram illustrating some shifting modes for the shifter of one embodiment of the present invention; and

FIG. 24 is a diagram illustrating the implementation of a turbo look up table of one embodiment of the present invention.

### DETAILED DESCRIPTION OF THE INVENTION

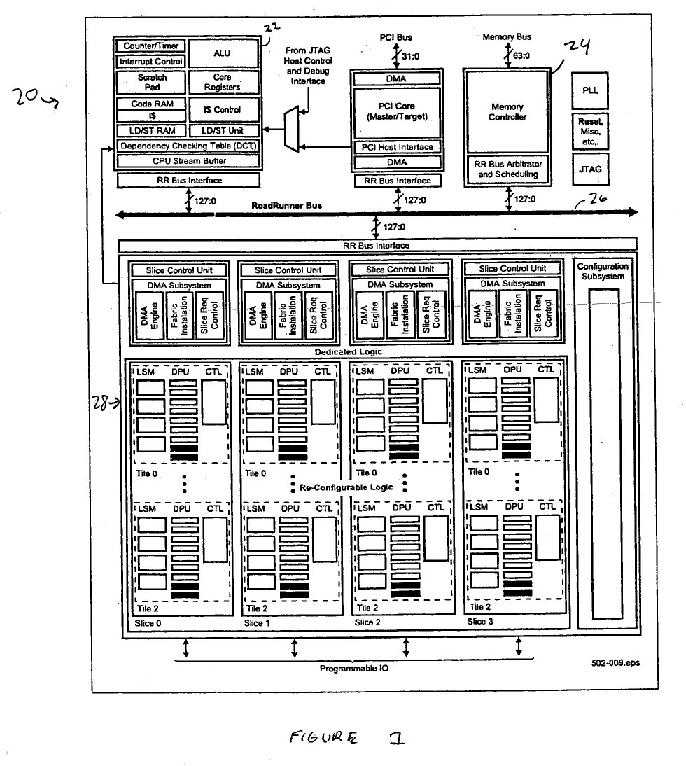

FIG. 1 illustrates a reconfigurable chip 20. The reconfigurable chip 20 includes a central processing unit (CPU) 22, preferably a reduced instruction set (RISC) CPU. Data from the external memory (not shown) is transferred using memory controller 24. Bus 26, called the roadrunner bus, is used to transfer data from the memory controller to the reconfigurable fabric 28. The reconfigurable fabric 28 is divided into a number of slices. Each slice is broken down into a number of tiles. Each tile includes a data path unit (reconfigurable functional unit), control units and local system memory units. The local system memory units interact with the data path units as described below. In a preferred embodiment, each tile also has a number of multiplier units.

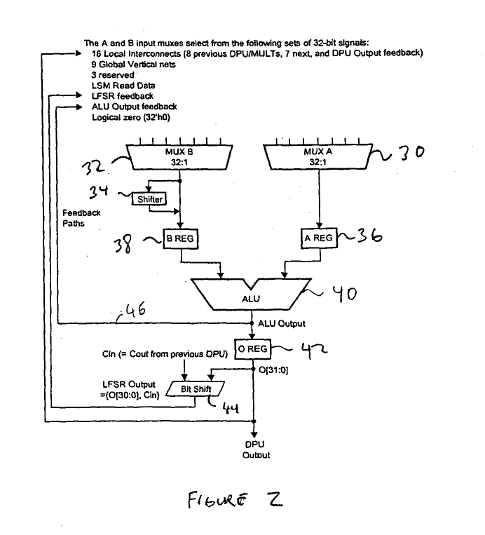

FIG. 2 illustrates a simplified diagram of a reconfigurable functional unit of one embodiment of the present invention. The reconfigurable functional unit includes input multipliers 30 and 32. As will be described below, the input multipliers allow the data path unit to receive inputs from a number of different locations, including nearby data path units as well as data buses. The selected output of the input multipliers are sent on to registers 36 and 38. Additionally, the output of the multiplier 32 goes to shifter unit 34. As described below, the shifter unit 34 allows for the selection of different bits to be operated on by the ALU 40. Since the interconnections between the data path units use fixed word length connections to simplify the interconnection system, the use of a shifter unit in the data path unit allows access to bits packed within the interior of a word.

As will be described below, the shifter unit 34 preferably has a number of modes which implement more than just logical and arithmetic shifts left and right. These different modes allow the system to operate in a more efficient manner. The arithmetic logic unit 40 described below, preferably uses a field of the instruction for the data path unit to implement a function. The output of the ALU 40 preferably goes to an output register 42. The output can also actually be sent to an optional bit shifter 44 to produce a shifted value.

In one embodiment, a bypassing ALU feedback output on line 46 is also used. This allows portions of the data path unit to operate while the output register 42 controls what outputs are sent from the data path unit. This is useful when the output register 42 is used to address a local system memory unit.

The bit shifter 44 is used to implement the linear feedback shift register as described in the patent application, “Modifications to Reconfigurable Functional Unit in a Reconfigurable Chip to Perform Linear Feedback Shift Register Function,” by Peter Lam, Attorney Docket No. 032001-060.

Note that the multiplexers, shifter unit 34 and ALU 40 are preferably controlled by an instruction for the data path unit. This instruction is preferably divided into a number of different fields, including multiplexer instruction fields for the multiplexers, shifter unit fields for the shifter 34 and ALU instruction field for the ALU 40. In one embodiment, a decoder is used for at least part of the instruction.

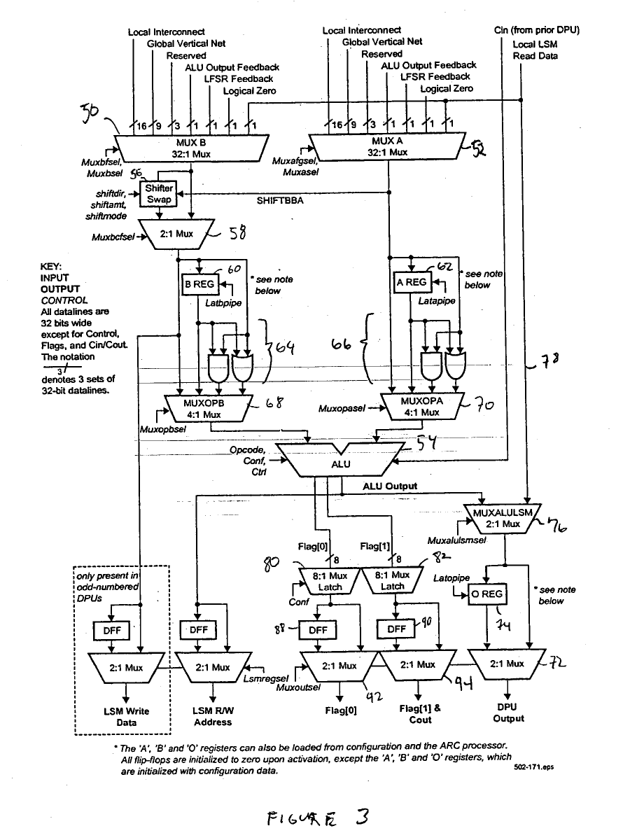

FIG. 3 is a detailed diagram of one embodiment of the present invention. The input multiplexers 50 and 52 receive as inputs data from nearby units. In one example, data words from 16 units, including data path units and multiplier units, are used as inputs. Global vertical and horizontal interconnections are used. In one embodiment a connection for the linear feedback shift register feedback, a logical zero constant input and an input for a local system memory unit. Another input is the carry input from the prior data path unit which is provided to the ALU 54 directly. The multiplexer 50 is connected to the shifter 56, including a number of different modes of operation. The shifter 56 is connected to another multiplexer 58 so that the output of the multiplexer 50 can either avoid or use shifter unit 56. The shifter unit 56 can also use the A input from the input multiplexer 52 for some of the modes. The output of the multiplexer 58 and the output of multiplexer 52 can be sent to registers 60 and 62, respectively. The registers 60 and 62 can also be loaded from off the chip. This logic 64 and 66 allows for the register values to act as a mask register for the system. The multiplexers 68 and 70 select the inputs to the ALU 54. Outputs to the ALU are sent to a number of different possible paths. Note that the data path output out of multiplexer 72 can be the value from the output register 74, or the value from the multiplexer 76 (which can be the ALU value or the local system memory re-data on line 78). The flag values from the ALU are sent to multiplexers 80 and 82 which select the desired flag value. This flag value can be stored in registers 88 and 90 and the value of the registers 88 or 90 is sent to the multiplexers 92 and 94 or the selected value from multiplier 80 or 82 is used. The CONF value is a field in the instruction that indicates which flag to select.

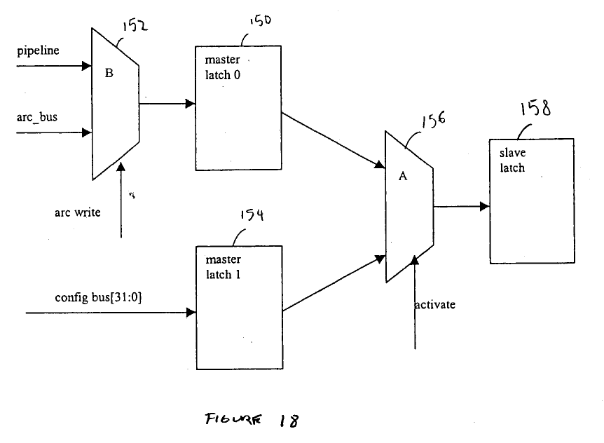

In one embodiment, the registers 60, 62 and 74 can be implemented by using multiple master slave latches, shown in FIG. 18, to allow the loading of background configuration data into the register. In one embodiment, the operation of these registers can be controlled by the field of the reconfigurable functional unit instruction.

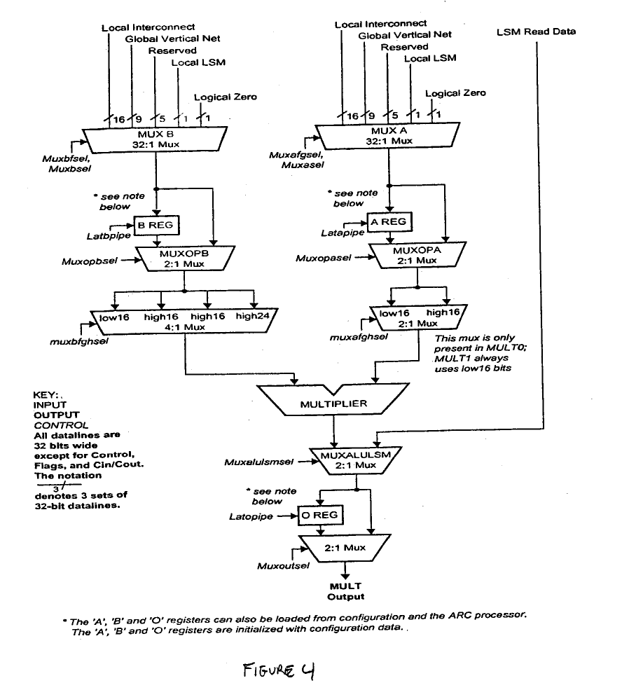

FIG. 4 is a diagram of a multiplier unit. The multiplier unit is oriented somewhat similar to the reconfigurable functional unit shown in FIG. 3. However, the multiplier unit has a dedicated multiplier rather than an ALU.

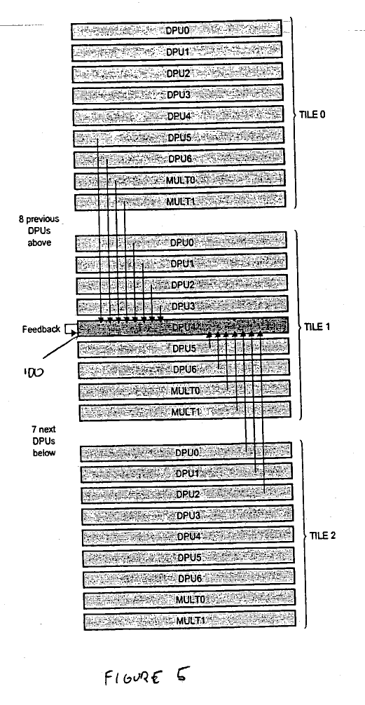

As shown in FIG. 5, in one embodiment for every seven data path units or reconfigurable functional units in a tile, there are two multiplier units.

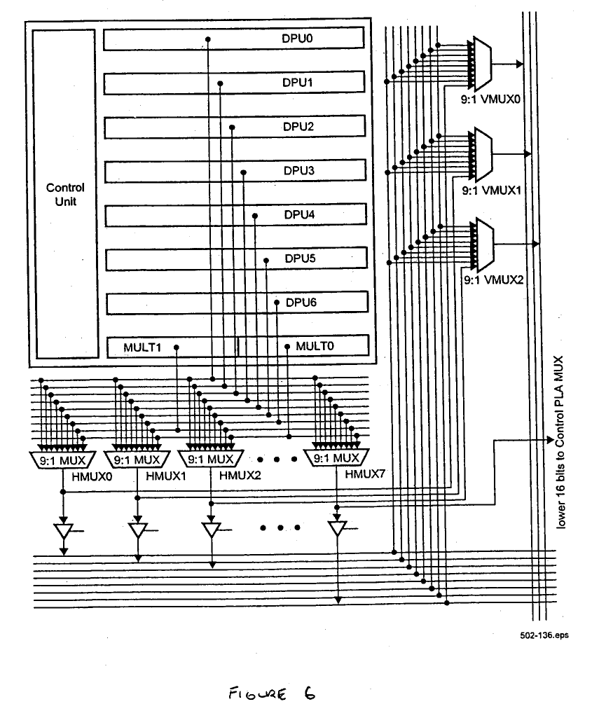

FIG. 6 illustrates the connections of adjacent data path units and multipliers into the data path unit inputs. Note looking at FIG. 5, the data path unit 100 can receive as an input, outputs from eight previous data path units (and multipliers) above and seven of the next data path units (and multipliers) below. The output of the data path unit 100 is also fed back to itself. The outputs of any of these units can be selected using the input multiplexers of the system for either the A or B inputs.

FIG. 6 is a diagram that illustrates the connection of the one tile reconfigurable functional units (data path units) to horizontal and vertical connection lines. By using multiplexers, the outputs, and inputs, of the data path units can be interconnected to both the vertical routing lines and the horizontal routing lines.

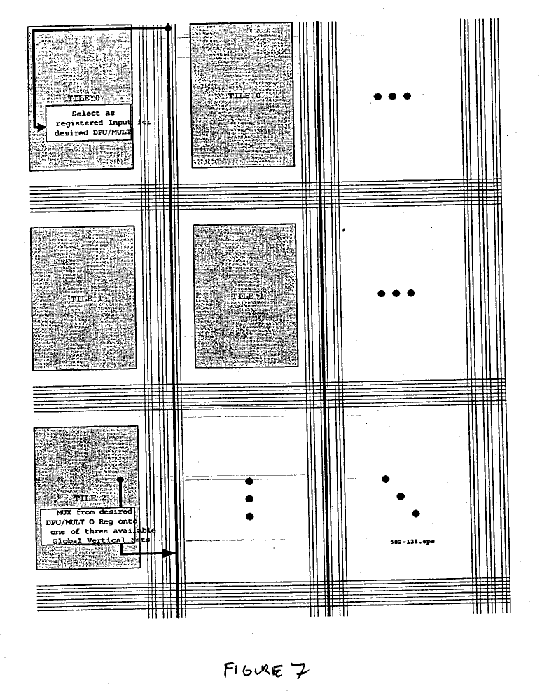

FIG. 7 illustrates an example of interconnecting a data path unit in one tile to a data path unit in another tile using vertical interconnected lines. Note that the system of the present invention for the interconnections preferably uses word-based interconnections. In one embodiment, the interconnection lines allow the connection of 32 bit wide data. The shifter unit in the data path unit allows for the alignment of the data once it is received into a data path unit from the interconnection system. Because the system sends data in a 32 bit word, the complexity of the interconnect system is reduced and simplified, reducing somewhat the flexibility of the interconnect.

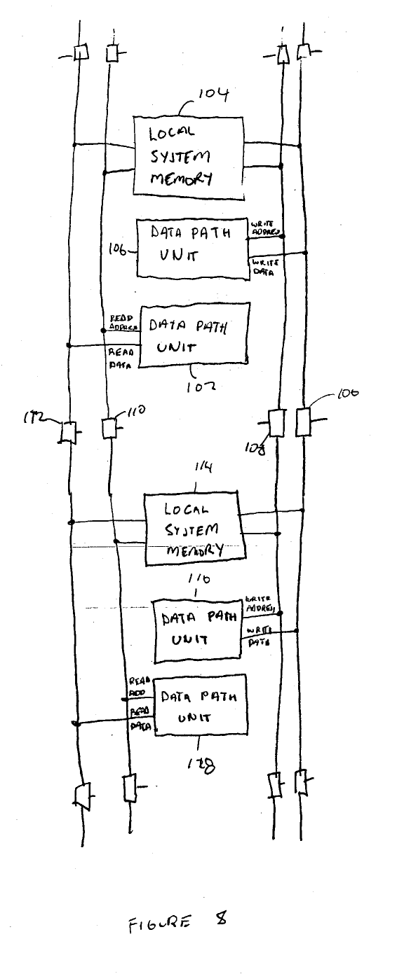

FIG. 8 illustrates the connection between the data path units and the local system memory. In a preferred environment, alternate data path units are used to implement the Writes and Reads of the local system memory. For example, data path unit 102 provides Read Addresses to and receives read data from the local system memory 104. Data path unit 106 provides the Write Address and Write data for the local system memory 104. Note that by using the pass gates such as pass gates 106, 108, 110 and 112, the data path units 102 and 106 can connect to other local system memories, such as local system memory 114 and the data path units 116 and 118 can connect to the local system memory 104. In another embodiment, a data path unit can both read from and write to a local system memory. One of the uses of a data path unit is to provide an address to a local system memory to obtain data from a local system memory, which can then be put upon the horizontal and vertical interconnection buses. The connections shown in FIG. 8 are the direct connections to read and write data in and out of the local system memory. In a preferred environment, the local system memory is globally read from and written to using the memory control system. This general memory control system is used for configuration of the system and for obtaining the data operated on by the data path units. Note that as described above, in a preferred embodiment, the data path units include structures that allow addresses and data to be provided to the local system memory while the data path unit does some other function.

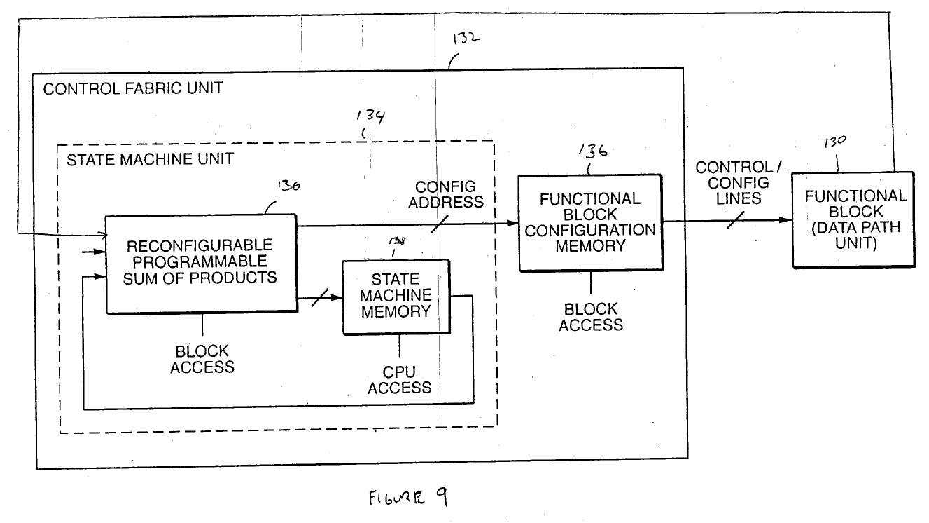

FIG. 9 is a disclosure of a control fabric unit 132 for the reconfigurable functional unit 130. In this embodiment, the control fabric unit 132 produces a control or instruction line for the reconfigurable functional unit 130. In this embodiment, the control fabric unit 132 is preferably composed of a state machine unit 134 and a functional block configuration memory unit 136. The state machine 134 produces the addresses into the instruction memory 136. One implementation of the state machine 134 uses a reconfigurable programmable sum-of-products unit 136.

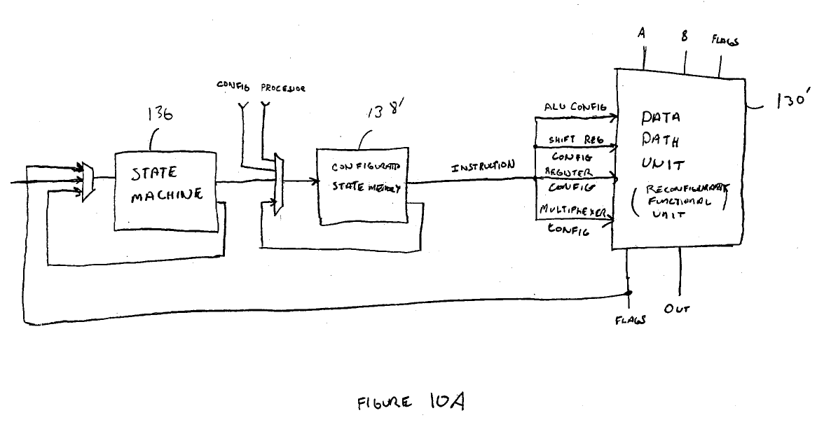

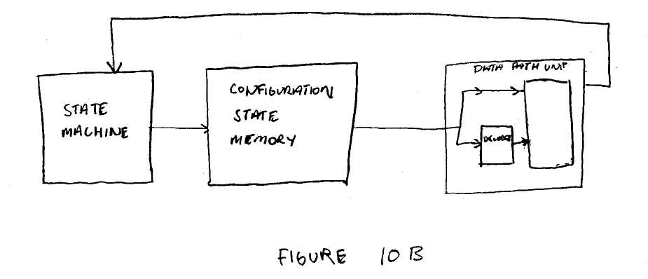

FIG. 10A illustrates a system with the state machine configuration unit 136, the configuration state memory 138′ and the data path unit 130′. Note that the configuration from the configuration state memory 138′ can be considered to be an instruction for the data path unit 130′. The instruction preferably includes fields such as an ALU configuration field, shift register configuration field, and a multiplexer configuration field. In one embodiment, some of the flags from the data path unit 130′ are sent to the state machine 136′ in order to switch configurations for the data path unit after the data path unit is done operating on a set of data. The configuration state machine 138′ can also be loaded from an external configuration from external memory or from the processor.

FIG. 10B is a diagram illustrating a data path unit using a decoder to decode at least part of an instruction.

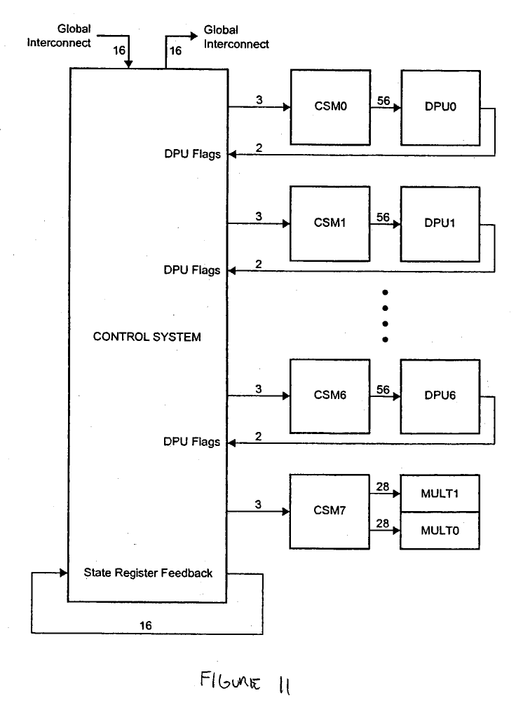

FIG. 11 shows the control system, including the state machines for the different configuration state memories. The data path unit flags are sent to the control system as described above.

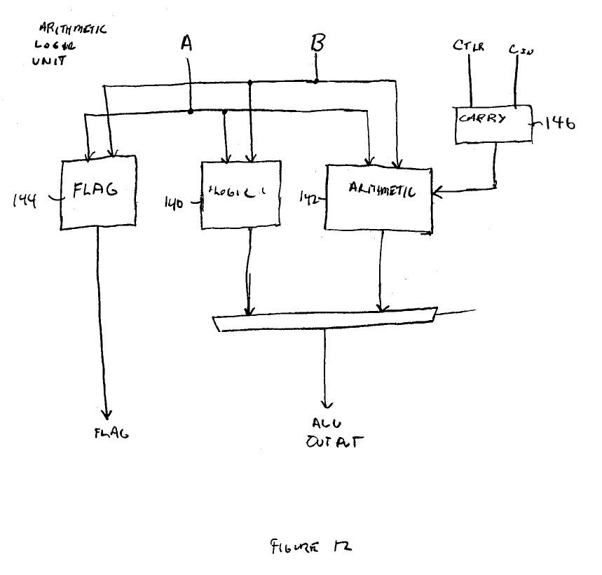

FIG. 12 is a diagram that illustrates one example of an arithmetic logic unit. This arithmetic logic unit includes an arithmetic unit 142, a parallel logic unit 140 and a flag unit 144. Also shown is a carry selection unit 146. The ALU instruction field from the instruction is sent to select the operations of the ALU. The arithmetic unit 142 uses a carry input. In a preferred embodiment, this carry value is either the carry from the previous data path unit or the control signal or a carry which is part of the instruction.

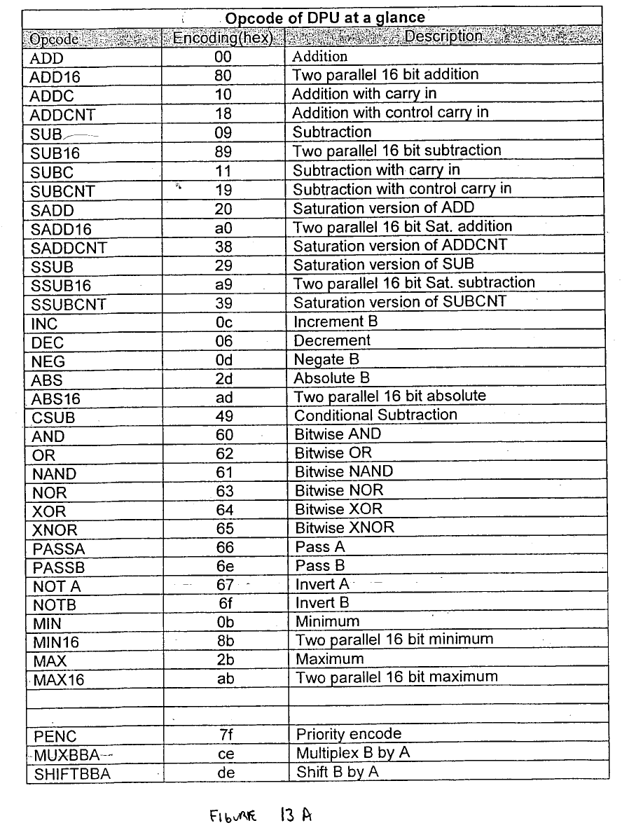

FIGS. 13A and 13B illustrate a list of some of the Opcodes used in one embodiment of an ALU of the reconfigurable functional unit of the present invention. Details of these Opcodes are described in the Appendix I, incorporated herein by reference.

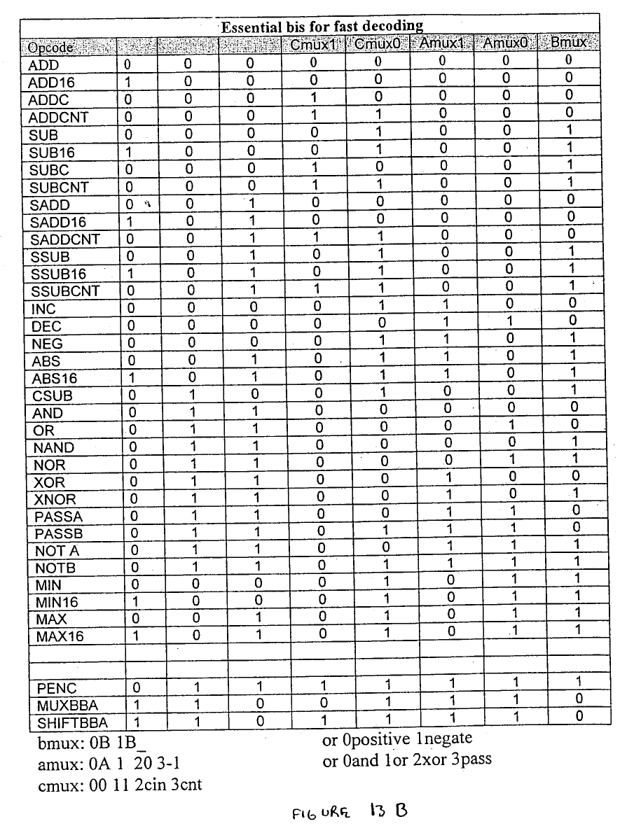

FIG. 14 is a diagram of the flag system for the present invention. The flag unit is inside the data path unit and used for producing the flags which go to the control unit as well as to the next data path unit. The selection of the flags which are used the control of a field of the reconfigurable functional instruction and are preferred by the present invention. A description of the some of the flags is given below.

ROXR is driven every cycle. It is selected by conf==1. The operation is:

| | |
|---|---|
| case opcode[7]= =0 | flag[1]= = \hat{ }(B[31:0]) |
| | flag[0]= = \hat{ }(B[15:0]) |
| case opcode[7]= = 1 | flag[1]= = \hat{ }(B[31:16]) |
| | flag[0]= = \hat{ }(B[15:0]) |

Abbreviations:

CO—Carry Out (of the addition/subtraction operation)

OV—Overflow (of the addition/subtraction operation)

EQ—Equal (A==B)

GT—Greater Than

LT—Less than

SN—Sign (sign bit of result)

Previous Flag

Cin—Carry in pevious row

Ctrl—Carry in from control

Max—Ox7fff[ffff] (for 16/32 bits)

Min—0x8000[0000] (for 16/32 bits)

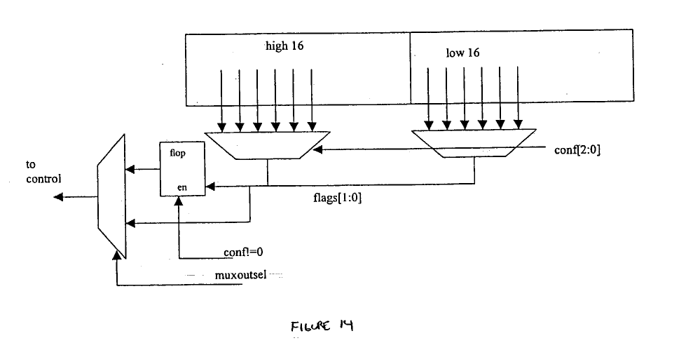

FIG. 15 illustrates the shift mode and the operation of some of the modes of the shifter unit of one embodiment of the present invention. Since the shifter unit has a number of different modes, the flexibility of the system of the present invention is increased.

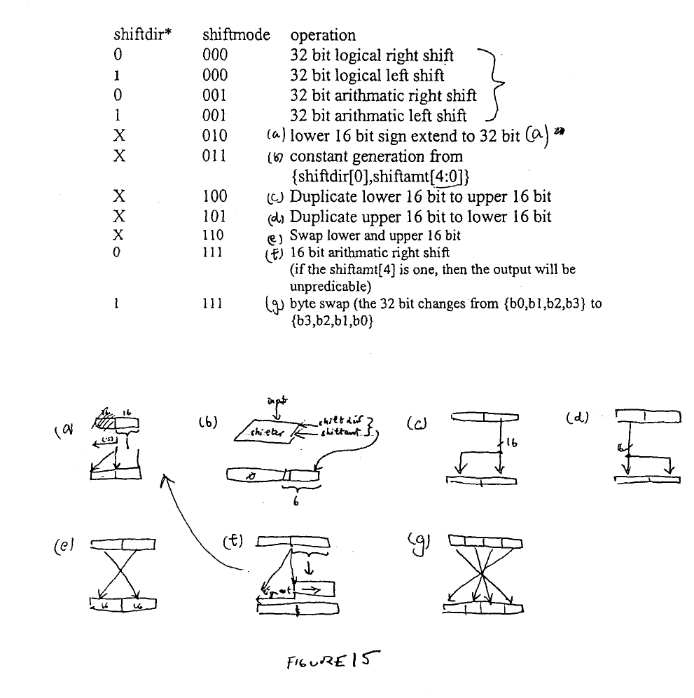

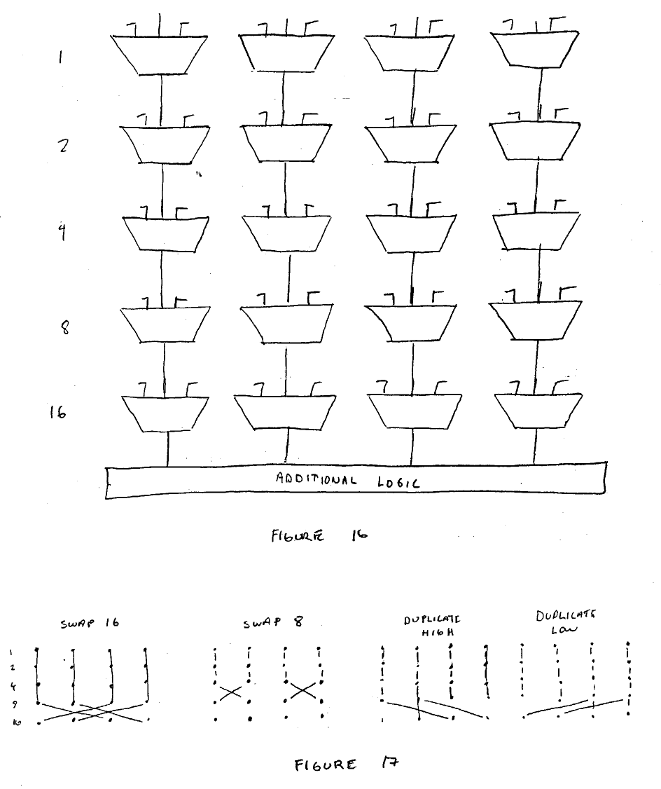

FIGS. 16 and 17 illustrate one implementation of the shifter unit using multiple rows of multiplexers. Additional logic is also of use to produce a special output. FIG. 17 illustrates the operation of some of the implementations of the shift register.

This shifter used in the Datapath unit performs more than right/left shift operations. The shifter includes an array of multiplexers which are controlled via mux select signals. In one 4×6 multiplexer array shifter embodiment, a 32-bit operand which is divided into four groups of 8 signals is coupled to a first row of four multiplexers. Other than the last row, the outputs of the multiplexers in a previous row are coupled to the inputs of the next row of multiplexers. Each multiplexer in the array is controlled independently. The control signals determine how the signals are routed in the array and hence the type of operation performed on the operand. In one embodiment, examples of operations include: 32-bit logical right/left shift, 32 bit arithmetic right/left shift, lower 16-bit sign extend to 32-bit, constant generation, duplicate lower 16 bit to upper 16 bit, duplicate upper 16 bit to lower 16-bit, swap lower and upper 16-bit, 16-bit arithmetic right shift, and byte swap.

FIG. 18 illustrates a multiple master latch system used in one embodiment of the system of the present invention. In this example, two master latches are used. One of the master latches is used for the background configuration of the system. The other master latch receives data from the pipeline in the data path unit or from the processor. The inputs to the latch 150 are provided through the multiplexer 152. The latch 154 is connected to the configuration bus to receive data from background configuration. The multiplexer 156 can be used to select the input to the slave latch 158. The use of a background configuration memory to the system allows the quick operation of the system in the present invention.

The storage element of FIG. 18 has multiple master latches which share a single slave latch via a multiplexer which provides a multi-function storage element. In addition, by sharing a slave latch a significant space savings is realized (approximately 25%). This is particularly true in a system utilizing numerous storage elements. The storage element design relies on the fact that configuration bits are infrequently loaded into storage elements. So instead of having a separate slave latch for each master latch coupled to a configuration bitstream signal, according to the invention the master latch coupled to the configuration bitstream signal shares its slave latch with another master latch. Hence, two or more master latches share a single slave latch. A multiplexer is coupled between the master latches and the single slave latch for selecting which master latch is coupled to the slave latch.

In one embodiment, one master latch's input is coupled to a signal that frequently requires the storage element functionality and the other master latch's input is coupled to a signal that requires the storage element functionality on an infrequent basis. In the first master latch is coupled to the data path signal and the second master latch is coupled to the configuration bit signal. When the data path signal is passed to the slave latch, the storage element functions to divide the data path pipeline into stages. When the configuration bitstream signal is passed to the slave latch, the storage element functions to store the configuration bits. In another embodiment, one master latch is coupled to the data path signal and more than one master latch is coupled to a configuration bit signal and all of the master latch outputs are coupled to the multiplexer which is used to select and pass one of the signals from the master latches to the shared slave latch.

For FIG. 18:

master latches are reset upon ‘RESET’ or ‘INIT’

slave latches are reset upon ‘RESET’ only

mux A selects config path whenever configuration is activating, (further qualified by the particular slice being selected)

mux B selects arc bus when arc is writing (further qualified by decoding corresponding arc_address. Please refer to ARC ext spec for address map)

master latches are transparent only during clock low

slave latches are transparent only during clock high

master latch 0 is transparent when the latpipe 0 is enabled or arc write to that register is happening

master latch 1 is transparent when config loading is activate and the corresponded config address is decoded

slave latch is transparent when

1. config activate to this slice or

2. arc write to this register or

3. latpipe signal from control is high

This setup is under the assumption that configuration and arc write will not happen at the same time. If it does happen, the configuration has higher priority.

Another embodiment of the present invention concerns the variable delay units of the present invention. Variable delay units are comprised of a multiplexer which receives first unit sent into a register and the second input which bypasses the register. In this way a variable delay can be implemented. In the reconfigurable functional unit of FIG. 3 the register 60, connected to the multiplexer 68 and the register 62 connected from multiplexer 70 and register 88 connected to the multiplexer 92, the register 90 connected to the multiplexer 94 and the register 74 connected to the multiplexer 72, can implement such a variable delay. A multiplexer can select a delayed or a bypass signal; the delay signal going through a delay element like a flip-flop.

The flexible adaptive delay element includes a storage device (e.g., flip-flop, latch) having its input coupled to an input signal and its output coupled to a first input of a multiplexer. The other input of the multiplexer is coupled to the input signal. As a result, the first input of the multiplexer is coupled to the input signal and a second input of the multiplexer is couple to the input signal delayed by the amount provided from the storage device. The select signal can then be used to select either the delayed signal or the undelayed signal.

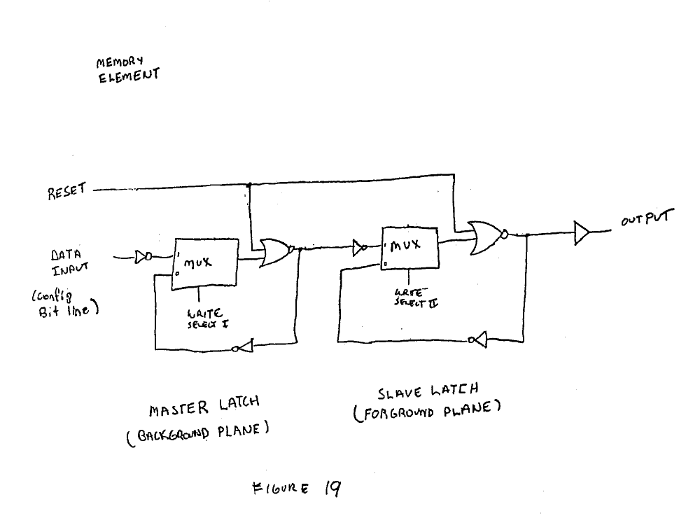

FIG. 19 shows an alternate embodiment of a background foreground plane arrangement

The present invention incorporates by reference the prior patent applications, including “A HIGH PERFORMANCE DATA PATH UNIT FOR BEHAVIORAL DATA TRANSMISSION AND RECEPTION,” Inventor Hsinshih Wang, Ser. No. 09/307,072 filed May 7, 1999 (Attorney Docket No. 032001-014), “CONTROL FABRIC FOR ENABLING DATA PATH FLOW,” Inventors Shaila Hanrahan, et al., Ser. No. 09/401,194 filed Sep. 23, 1999 (Attorney Docket No. 032001-016), as well as “CONFIGURATION STATE MEMORY FOR FUNCTIONAL BLOCKS ON A RECONFIGURABLE CHIP,” Inventors Shaila Hanrahan and Christopher E. Phillips, Ser. No. 09/401,312, and filed on Sep. 23, 1999 (Attorney Docket No. 032001-035).

Vermont Embodiments.

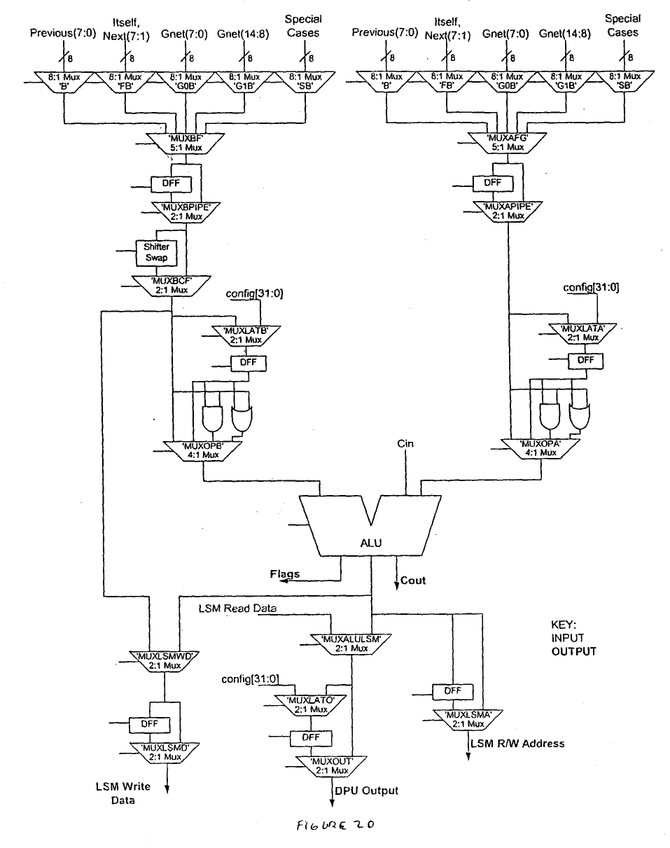

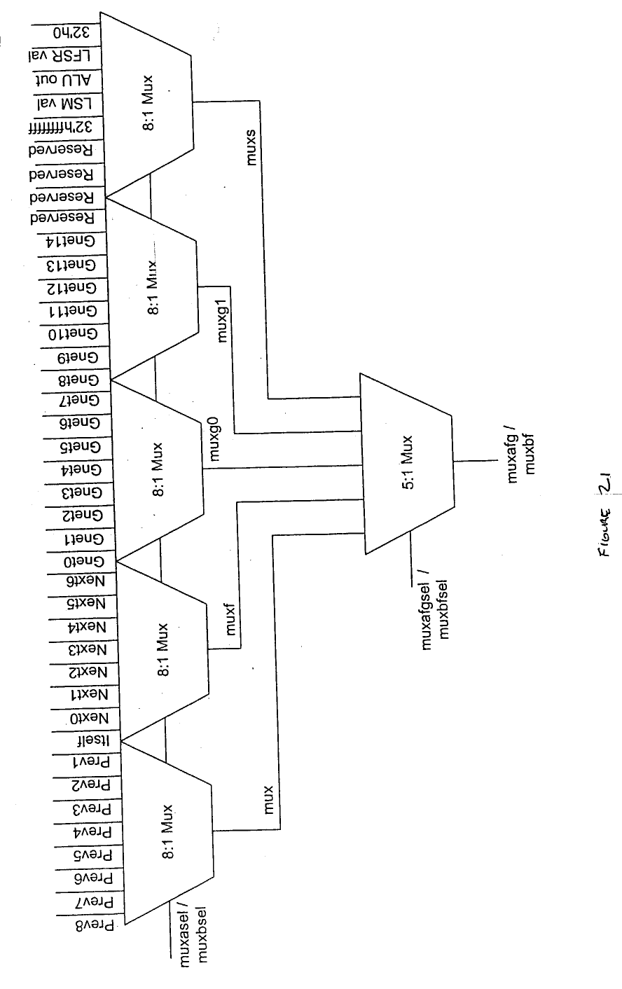

FIG. 20 illustrates a ultimate embodiment of the reconfigurable functional unit or data path unit. In this embodiment an additional register and multiplexer are added to the B input path before the shifter. Additionally, the input multiplexer is slightly modified. The input multiplexer is shown with respect to FIG. 21.

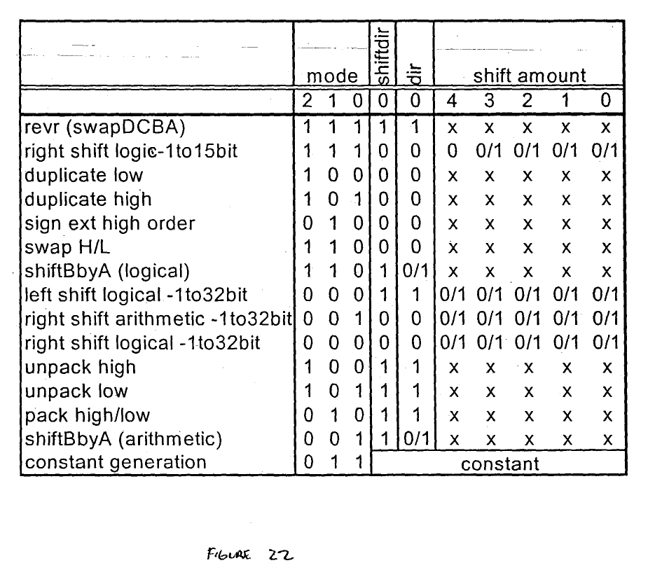

FIG. 22 illustrates the shifter mode table for the new embodiment of FIG. 19.

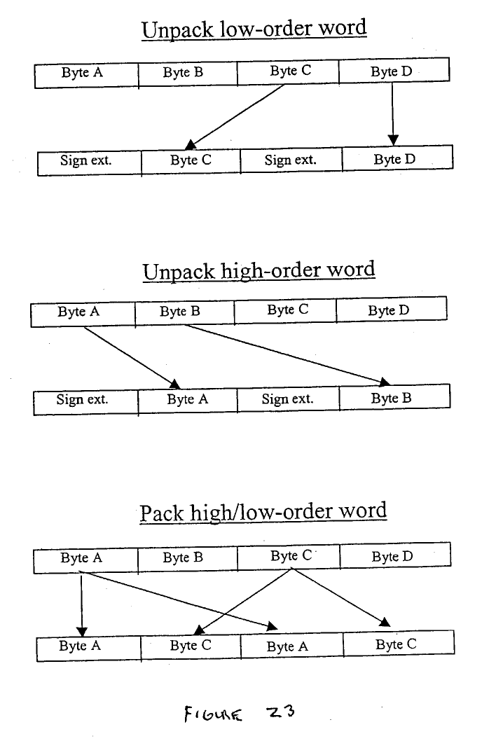

FIG. 23 illustrates the implementation of the new modes of FIG. 22.

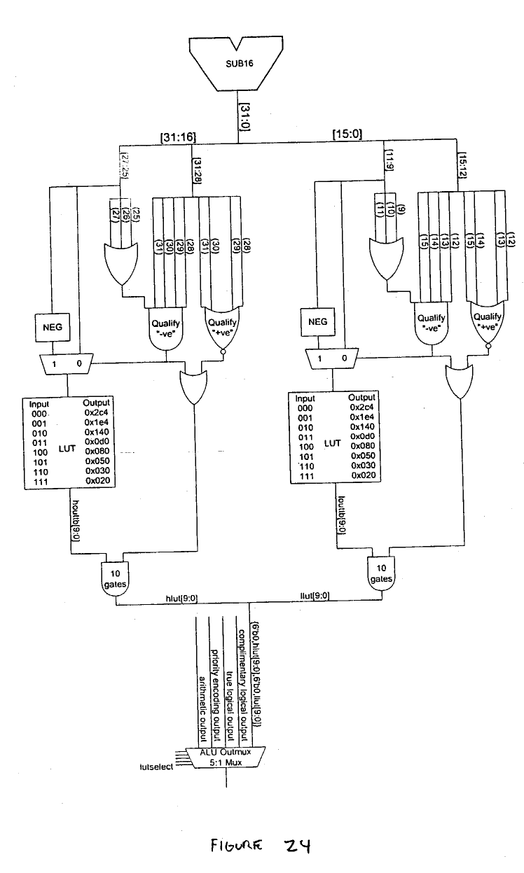

FIG. 24 illustrates a turbo look up table for use with the system of the present invention. The turbo look up table is useful in the addition of data stored in a logarithmic format. This is useful for many communication systems. In one prior embodiment in order to do the multiplication of data stored in logarithmic format, the data must be converted to the normal format by doing an exponential expansion of the data. The exponentially expanded data is added together and then the combined information is converted back to the logarithmic format. In the preferred embodiment, the turbo look up table is used in the production of an estimate of the addition of a correction factor. This estimate uses the value of the greatest value of A and B as a first estimate of the value of addition of A plus B. The absolute value of this difference of A minus B is used as an input to a look up table to provide a correction factor to add to the greatest value of A or B. By adding this correction factor to the greatest value of A or B a relatively accurate estimation is produced. Note that the look up table need not have the same number of input bits of A. In a preferred embodiment, only a few bits of precision are used. If the magnitude of A minus B is relatively large, the combined value does not significantly differ from the greatest value of A or B. For example, the addition of 1,000,000 to 0.1 is approximately 1,000,000. The addition of 1,000,000 to 1,000,000 is effectively doubling the maximum value.

Appendixes II and III further illustrate the Vermont embodiment of the reconfigurable functional unit.

It will be appreciated by those of ordinary skill in the art that the invention can be implemented in other specific forms without departing from the spirit or character thereof. The presently disclosed embodiments are therefore considered in all respects to be illustrative and not restrictive. The scope of the invention is illustrated by the appended claims rather than the foregoing description, and all changes that come within the meaning and range of equivalents thereof are intended to be embraced herein.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A reconfigurable chip including:
Multiple reconfigurable functional units adapted to implement different functions, the reconfigurable functional units including multiplexers, at least one shifter unit and at least one arithmetic logic unit, the reconfigurable functional units being configured by a reconfigurable functional unit instruction, the instruction controlling the configuration of the multiplexers, shifter unit and arithmetic logic unit; and
Interconnect elements adapted to selectively connect together some of the reconfigurable functional units.

2. The reconfigurable chip of claim 1 wherein the reconfigurable functional unit instruction is divided into a number of fields, including a multiplexer field, a shifter unit field and an arithmetic logic unit field.

3. The reconfigurable chip of claim 1 wherein the reconfigurable functional unit comprised of the data path unit.

4. The reconfigurable chip of claim 1 wherein the interconnect element are adapted to transfer word length data.

5. The reconfigurable chip of claim 4 wherein the word length data are 32 bits long or greater.

6. The reconfigurable chip of claim 1 further comprising an instruction memory storing multiple instructions for the reconfigurable functional units.

7. The reconfigurable chip of claim 1 wherein the shifter unit is configurable with a number of modes.

8. The reconfigurable chip of claim 7 wherein the reconfigurable functional unit instruction includes a shifter unit field which controls the mode of the shifter unit.

9. The reconfigurable chip of claim 1 wherein at least one of the multiplexers is associated with a delay unit input and any input that bypasses the delay unit to implement variable delay system.

10. The reconfigurable chip of claim 1 wherein the reconfigurable functional unit include registers for temporarily storing values within the reconfigurable functional unit.

11. A reconfigurable chip including:
multiple reconfigurable functional units, the reconfigurable functional units including multiplexers, at least one shifter unit and at least one arithmetic logic unit, the shifter unit adapted to allow the arithmetic logic units to operate on different bits within the word-length input data of the reconfigurable functional unit; and
Interconnect elements adapted to selectively connect together some of the reconfigurable functional units, the interconnect elements adapted to transfer word-length data.

12. The reconfigurable chip of claim 11 wherein the word length data are 32 bits or greater.

13. The reconfigurable chip of claim 12 wherein the word length data are 32 bits long.

14. The reconfigurable chip of claim 11 wherein the reconfigurable functional units are configured by reconfigurable functional unit instruction. The instruction controlling the configuration of the multiplexers, shifter unit and arithmetic logic unit.

15. The reconfigurable chip of claim 11 wherein the reconfigurable chip further comprises an instruction memory storing multiple instructions for the reconfigurable functional unit.

16. The reconfigurable chip of claim 11 wherein the shifter unit is configurable with a number of different modes.

17. The reconfigurable chip of claim 11 wherein some of the multiplexers are associated with a delay unit input and an input that bypasses the delay unit.

18. A reconfigurable chip including:
multiple reconfigurable functional units, the reconfigurable functional units including multiplexers, at least one shifter unit and at least one arithmetic logic unit, the reconfigurable functional units being configured by a reconfigurable functional unit instruction, the instruction controlling the configuration of the multiplexers, shifter unit and arithmetic control unit; and
an instruction memory storing multiple instructions for the reconfigurable functional units.

19. The reconfigurable chip of claim 18 wherein an instruction memory is associated with each reconfigurable functional unit.

20. The reconfigurable chip of claim 18 wherein the instruction memory is associated with a state machine producing an address for the instruction memory.

21. The reconfigurable chip of claim 18 wherein the reconfigurable functional unit instruction includes fields for configuring the multiplexer, a shifter unit control field and an arithmetic logic unit control field.

22. The reconfigurable chip of claim 18 further comprising an interconnect elements adapted to selectively connect together some of the reconfigurable functional units.

23. The reconfigurable chip of claim 22 wherein the interconnect units adapted to transfer word length data.

24. The reconfigurable chip of claim 18 wherein the shifter unit is configurable with a number of modes.

25. The reconfigurable chip of claim 24 wherein the shifter unit is controlled by a shifter unit field, the reconfigurable unit instruction.

26. The reconfigurable chip of claim 18 wherein at least one of the multiplexers is associated with a delay unit input and an input that bypasses the delay unit so that a variable delay can be implemented.

27. A reconfigurable chip including:
multiple reconfigurable functional units, the reconfigurable functional units including multiplexers, at least one shifter unit and at least one arithmetic logic unit, the shifter unit being configurable with a number of modes; and
Interconnect elements adapted to selectively connect together some of the reconfigurable functional units.

28. The reconfigurable of claim 27 wherein the shifter modes include modes other than logical and arithmetic left and right shifts.

29. The reconfigurable chip of claim 27 wherein at least one mode rearranges blocks of the input word.

30. The reconfigurable chip of claim 27 wherein one of the modes comprises a constant generation.

31. The reconfigurable chip of claim 27 wherein one of the modes comprises the duplication of one set of bits to another set of bits.

32. The reconfigurable chip of claim 27 wherein one of the modes comprises swapping some of the groups of bits with other groups of bits.

33. The reconfigurable chip of claim 27 wherein the reconfigurable functional units are configured by reconfigurable functional unit instructions. The reconfigurable functional unit instruction configuring the arithmetic logic unit, shifter unit and multiplexers.

34. The reconfigurable chip of claim 33 wherein the reconfigurable functional unit instruction includes a field for controlling the shifter unit which controls the mode of the shifter unit.

35. The reconfigurable chip of claim 27 wherein the interconnect elements are adapted to transfer word length data.

36. The reconfigurable chip of claim 27 wherein the further comprising instruction memory storing instructions for the reconfigurable functional unit.

37. The reconfigurable chip of claim 27 wherein at least one of the multiplexers is associated with the delay input unit and an input that bypasses the delay unit so as to implement a variable delay.

38. A reconfigurable chip including:
multiple reconfigurable functional units, the reconfigurable functional units including multiplexers, at least one shifter unit and at least one arithmetic logic unit, wherein at least one of the multiplexers are associated with a delay unit input and an input that bypasses the delay unit; and
Interconnect elements adapted to selectively connect together some of the reconfigurable functional units.

39. The reconfigurable chip of claim 38 wherein the reconfigurable functional units are reconfigured by a reconfigurable functional unit instruction, the instruction controlling the configuration of the multiplexer, shift unit and arithmetic logic unit.

40. The reconfigurable chip of claim 39 wherein the reconfigurable functional unit instruction includes a number of different fields for controlling the configuration of the multiplexers, shifter unit and arithmetic logic unit.

41. The reconfigurable chip of claim 39 wherein a field of an instruction for the reconfigurable functional unit indicates the mode of the abstract.

42. The reconfigurable chip of claim 38 wherein the interconnect elements are adapted to transfer word length data.

43. The reconfigurable chip of claim 38 wherein further comprising instruction memory storing multiple instructions for the reconfigurable functional units.

44. The reconfigurable chip of claim 38 wherein the reconfigurable functional units include a shifter unit configurable with a number of different modes.
